(19) United States
(12) Patent Application Publication
(10) Pub. No.: US 2003/0080826 A1
(43) Pub. Date: May 1, 2003

(54) Method of shortening a microwave circuit and the printed circuit board made by using said method

(76) Inventors: Walker Chen, Taoyuan Hsien (TW); Wen-Yen Lin, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/984,481

(22) Filed: Oct. 30, 2001

(51) Int. Cl. H01P 3/08

(52) U.S. Cl. 333/117; 333/246

(57) ABSTRACT

The present invention relates to a method of shortening a microwave circuit and a printed circuit board made by using the method. The effective dielectric constant of the dielectric material of the microwave circuit may be increased, thereby efficiently achieving the purpose of shortening the size of the microwave circuit, thereby increasing the usage of the area of the circuit board, and thereby reducing production of noise.

### BACKGROUND OF THE INVENTION

1. Field of the Invention

The present invention relates to a method of shortening a microwave circuit and a printed circuit board made by using the method, wherein the effective dielectric constant of the dielectric material of the microwave circuit may be increased, thereby efficiently achieving the purpose of shortening the size of the microwave circuit, thereby increasing the usage of the area of the circuit board, and thereby reducing production of noise.

2. Description of the Related Art

In general, a printed circuit board includes multiple microwave circuits, such as the power distributors, the couplers, the wave filters, the wavelength converters, the modulators or the like. The wavelength of the microwave is very short, so that the wavelength of the microwave and the size of the circuit belong to the same grade. Thus, many electrical parameters, such as resistance, inductance, capacitance, conductance or the like, that may be omitted in the low-frequency alternating circuit, have to be considered in the microwave circuit. Change of the size of the microwave circuit will affect the values of the above-mentioned electrical parameters. The microwave circuit may maintain its function only at a determined wavelength (or frequency) and size, so that when the size of the microwave circuit is changed, the microwave circuit will lose its function. Thus, the size of the microwave circuit cannot be shortened arbitrarily, so that the microwave circuit occupies a considerable space in the printed circuit board. Therefore, the printed circuit board cannot be miniaturized, so that it cannot satisfy the requirements of light, thin, short and small designs.

Traditionally, a microwave circuit includes multiple transmission lines with proper sizes to form a proper geometry.

FIG. 1 shows a conventional branch-line coupler of a microwave circuit.

FIG. 2 shows a conventional hybrid-ring coupler of a microwave circuit.

FIG. 3 shows a conventional quarter-wave converter of a microwave circuit.

Each of the conventional microwave circuits in accordance with the prior art shown in FIGS. 1-3 comprises a dielectric substrate 11, a metallic ground layer 12 mounted on one side of the dielectric substrate 11, and a line layer 13 mounted on the other side of the dielectric substrate 11. The line layer 13 consists of multiple microstrip transmission lines.

The wavelength of the microstrip transmission line of the line layer 13 can be calculated as flows:

λ_{g}×f=c/√∈_{eff}

Wherein, c is the velocity of light, and is equal to 3×10⁸ m/sec, ∈_{eff} is the effective dielectric constant, f is the frequency of the electromagnetic wave, and λ_{g} is the wavelength of the electromagnetic wave under this effective dielectric constant.

It is known from the above equation that, when the frequency is fixed, if the effective dielectric constant is increased, the wavelength of the electromagnetic wave under this effective dielectric constant may be shortened. Thus, the size of the microwave circuit that is proportional to the wavelength may be shortened. Therefore, when the effective dielectric constant is increased, the size of the microwave circuit may be shortened.

Further, when the media of the microstrip transmission line or the microwave circuit are not even, it is assumed that the equivalent media of the microstrip transmission line or the microwave circuit are even, and the dielectric constant of the equivalent media is the effective dielectric constant ∈_{eff}. The effective dielectric constant may be calculated as follows:

∈_{eff}=C_{substrate}/Cₐᵢᵣ

wherein, C_{substrate} is the capacitance of the microstrip transmission line or the non-metallic part of the microwave circuit after being filled with the media, and Cₐᵢᵣ is the capacitance of the air.

At this time, distribution of the dielectric media may be not even, and the microstrip transmission line or the non-metallic part of the microwave circuit is filled with the capacitance of the air. If distribution of the dielectric media is not even, and the dielectric media consist of two dielectric materials, wherein one dielectric material has a higher dielectric constant, and the other has a lower dielectric constant, such that the effective dielectric constant is between the two dielectric constants. Thus, a high dielectric value material may be coated on the entire line layer of the microwave circuit, or coated on partial transmission lines of the line layer, thereby increasing the effective dielectric constant, so as to efficiently shorten the size of the microwave circuit.

### SUMMARY OF THE INVENTION

The primary objective of the present invention is to provide a method of shortening a microwave circuit and a printed circuit board made by using the method, wherein the effective dielectric constant of the dielectric material of the microwave circuit may be increased, thereby achieving the purpose of shortening the size of the microwave circuit, thereby increasing the usage of the area of the circuit board, and thereby reducing production of noise.

In accordance with a first aspect of the present invention, there is provided a method of shortening a size of a microwave circuit, comprising the steps of:

a) determining a pre-estimated value of an effective dielectric constant;

b) determining a shortened size of a microwave circuit according to the pre-estimated value of the effective dielectric constant and a used working frequency;

c) making the microwave circuit according to the shortened size that is determined; and

d) means for increasing an effective dielectric constant of the dielectric material of the microwave circuit to be equal to the pre-estimated value of the effective dielectric constant.

In accordance with a second aspect of the present invention, there is provided a printed circuit board, comprising:

a dielectric substrate;

a metallic ground layer mounted on a first side of the dielectric substrate;

a line layer mounted on a second side of the dielectric substrate; and

a high dielectric value material mounted on the line layer.

In accordance with a third aspect of the present invention, there is provided a printed circuit board, comprising:

a dielectric substrate made of a high dielectric value material;

a metallic ground layer mounted on a first side of the dielectric substrate; and

a line layer mounted on a second side of the dielectric substrate.

Further benefits and advantages of the present invention will become apparent after a careful reading of the detailed description with appropriate reference to the accompanying drawings.

### BRIEF DESCRIPTION OF THE DRAWINGS

FIG. 1 shows a conventional branch-line coupler of a microwave circuit in accordance with the prior art;

FIG. 2 shows a conventional hybrid-ring coupler of a microwave circuit in accordance with the prior art;

FIG. 3 shows a conventional quarter-wave converter of a microwave circuit in accordance with the prior art;

FIG. 4 is a perspective view of a shortened branch-line coupler of a microwave circuit in accordance with a preferred embodiment of the present invention;

FIG. 5 is a cross-sectional view of the shortened branch-line coupler of a microwave circuit as shown in FIG. 4;

FIG. 6 is a perspective view of a shortened branch-line coupler of a microwave circuit coated with a high dielectric value material in accordance with a preferred embodiment of the present invention;

FIG. 7 is a cross-sectional view of the shortened branch-line coupler of a microwave circuit as shown in FIG. 6;

FIG. 8 is a perspective view of a shortened branch-line coupler of a microwave circuit coated with a high dielectric value material in accordance with another preferred embodiment of the present invention;

FIG. 9 is a cross-sectional view of a shortened branch-line coupler of a microwave circuit coated with a conductive layer in accordance with the present invention;

FIG. 10 is a cross-sectional view of a microwave circuit used in a multi-layer printed circuit board in accordance with the present invention;

FIG. 11 is a cross-sectional view of a microwave circuit used in a multi-layer printed circuit board in accordance with the present invention;

FIG. 12 is a cross-sectional view of a microwave circuit used in a multi-layer printed circuit board in accordance with the present invention;

FIG. 13 is a cross-sectional view of a microwave circuit used in a multi-layer printed circuit board in accordance with the present invention;

FIG. 14 is a cross-sectional view of a microwave circuit used in a multi-layer printed circuit board in accordance with the present invention; and

FIG. 15 is a cross-sectional view of a microwave circuit used in a multi-layer printed circuit board in accordance with the present invention.

### DETAILED DESCRIPTION OF THE INVENTION

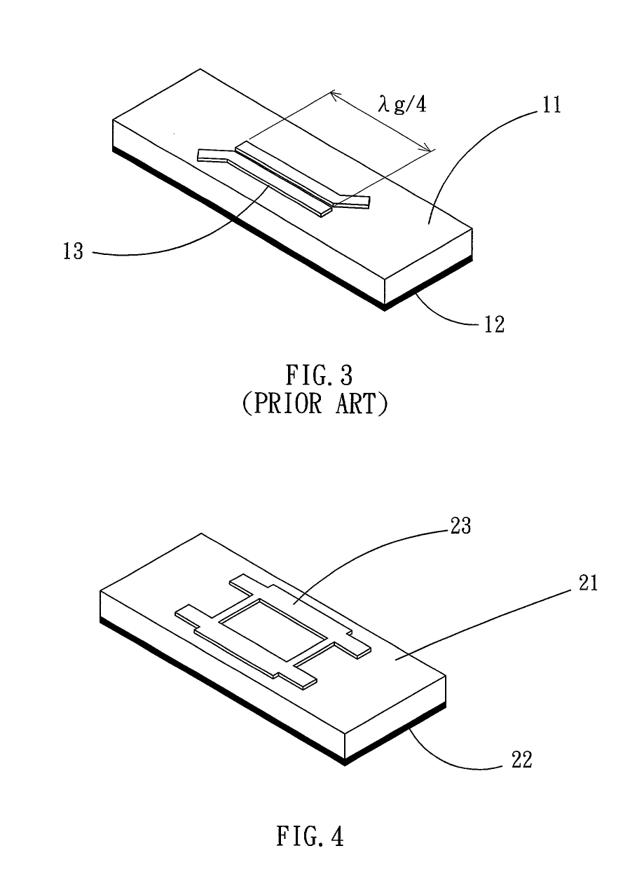

Referring to the drawings and initially to FIGS. 4-7, a branch-line coupler in accordance with a preferred embodiment of the present invention comprises a dielectric substrate 21, a metallic ground layer 22 mounted on one side of the dielectric substrate 21, and a line layer 23 mounted on the other side of the dielectric substrate 21.

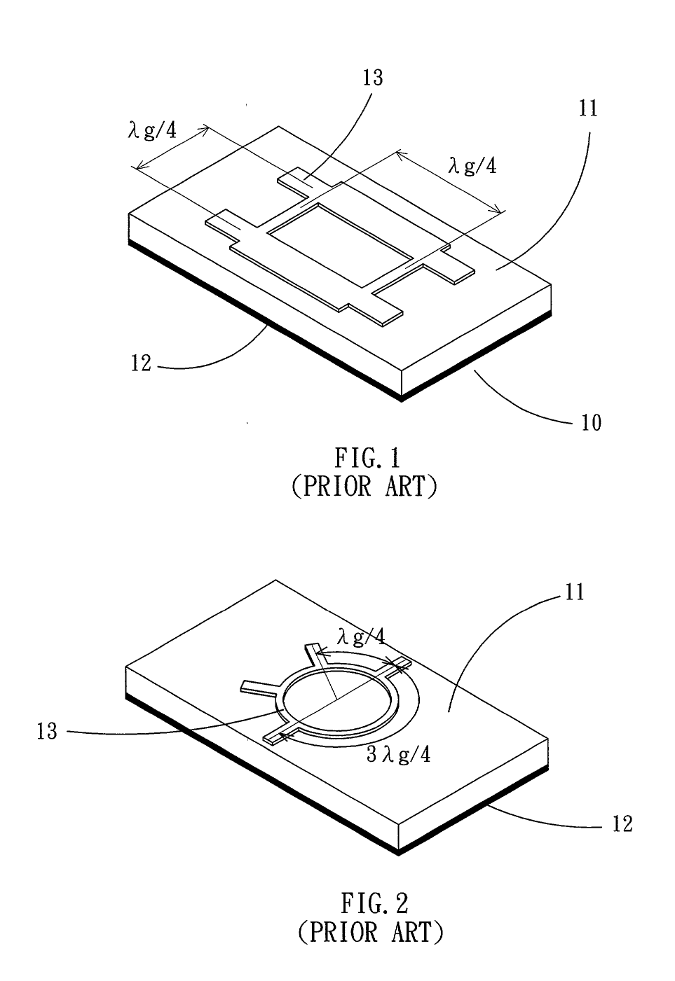

As shown in FIG. 1, the effective dielectric constant of the dielectric material is equal to 4, and the working frequency of the electromagnetic wave is set at 1 GH_{z}. Then, the size of each side of the microwave circuit needs to be equal to 3.75 centimeter.

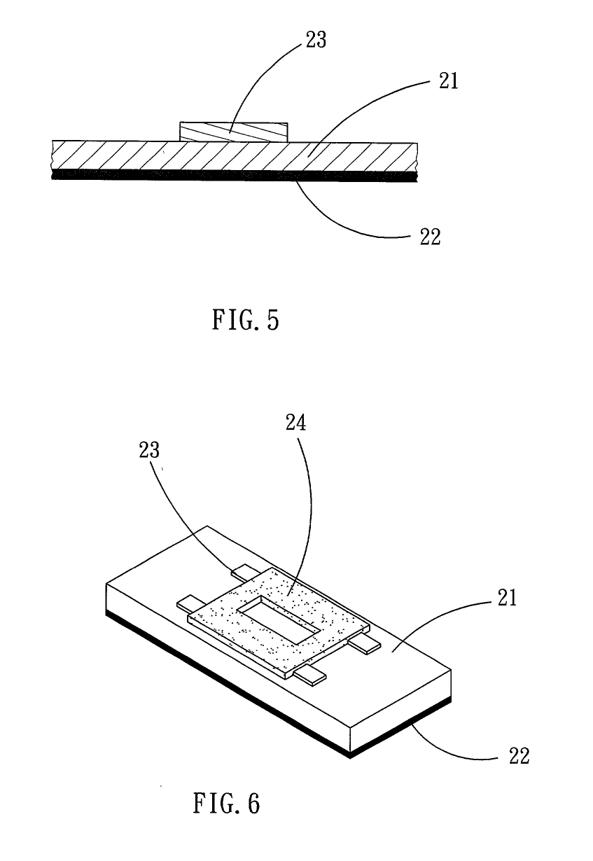

As shown in FIGS. 4 and 5, the effective dielectric constant of the dielectric material is pre-estimated to be increased to 9. Then, the size of each side of the microwave circuit may be equal to 2.5 centimeter, thereby forming a branch-line coupler with a smaller size.

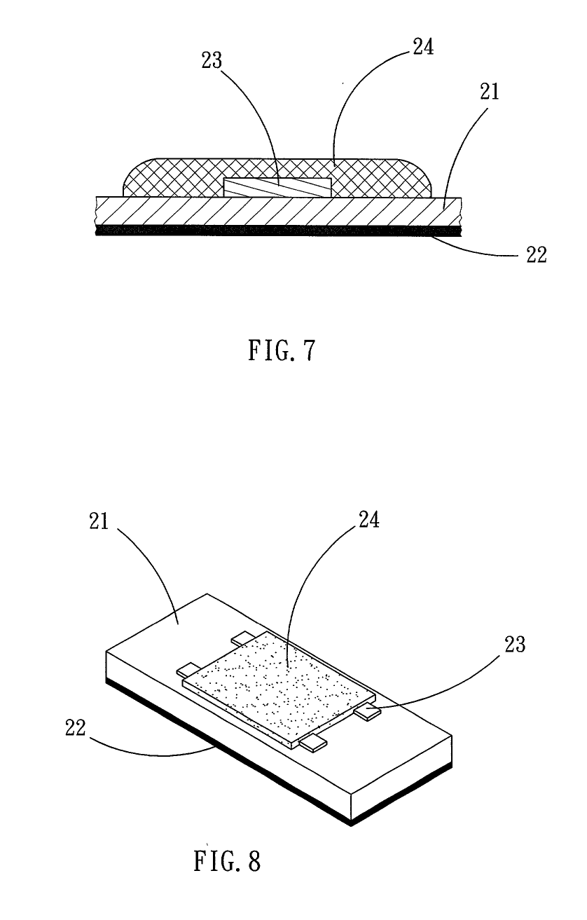

As shown in FIGS. 6 and 7, after the metallic ground layer 22 is mounted on one side of the dielectric substrate 21, and the line layer 23 is mounted on the other side of the dielectric substrate 21, a high dielectric value material 24 may be coated or printed on the line layer 23 of the microwave circuit, thereby increasing the effective dielectric constant of the dielectric material to 9, such that the size of the microwave circuit may be shortened efficiently by increasing the effective dielectric constant of the dielectric material, without affecting the electrical function of the microwave circuit.

As shown in FIG. 6, the high dielectric value material 24 may cover part of the line layer 23 of the microwave circuit.

As shown in FIG. 8, the high dielectric value material 24 may cover the entire line layer 23 of the microwave circuit.

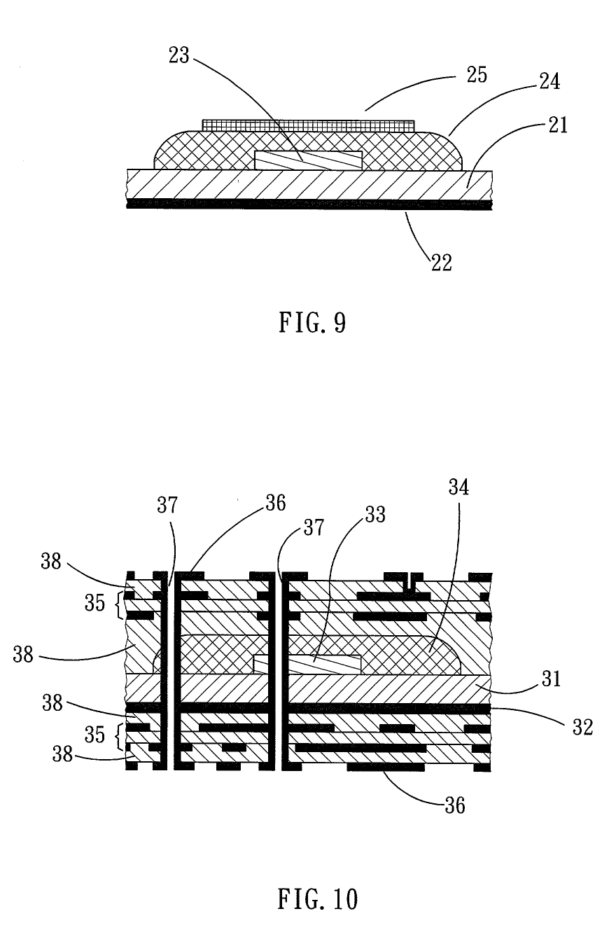

As shown in FIG. 9, a conductive layer 25 is coated or printed on the high dielectric value material 24, thereby preventing radiation leakage of the electromagnetic wave, and reducing consumption of energy.

The high dielectric value material 24 may be formed by adding ceramic powder (such as BaTiO3) in the resin, and the dielectric constant of the high dielectric value material 24 is better greater than 5. The conductive layer 25 may be formed by adding metallic powder in the resin, or formed of high molecular material of high conductance.

Alternatively, the dielectric substrate 21 may be made of a high dielectric value material that may increase the effective dielectric constant of the dielectric material to 9. Then, the metallic ground layer 22 is mounted on one side of the dielectric substrate 21, and the line layer 23 is mounted on the other side of the dielectric substrate 21, thereby forming the microwave circuit having a shortened size. Thus, the size of the microwave circuit may be shortened efficiently by increasing the effective dielectric constant of the dielectric material, without affecting the electrical function of the microwave circuit.

The method of the present invention may used in a single-layer printed circuit board as described above.

The method of the present invention may used in a multi-layer printed circuit board as described below.

Referring to FIG. 10, a microwave circuit made by the method in accordance with the present invention comprises a dielectric substrate 31, a metallic ground layer 32 mounted on one side of the dielectric substrate 31, a line layer 33 mounted on the other side of the dielectric substrate 31, and a high dielectric value material 34 coated on the line layer 33. The microwave circuit then overlaps other circuit substrates 35 and an outer copper layer by prepregs 38. The outer copper layer is then etched, thereby forming outer layer lines 36 that are formed with copper through holes 37 to connect the lines between the multiple layers, thereby forming a multi-layer printed circuit board.

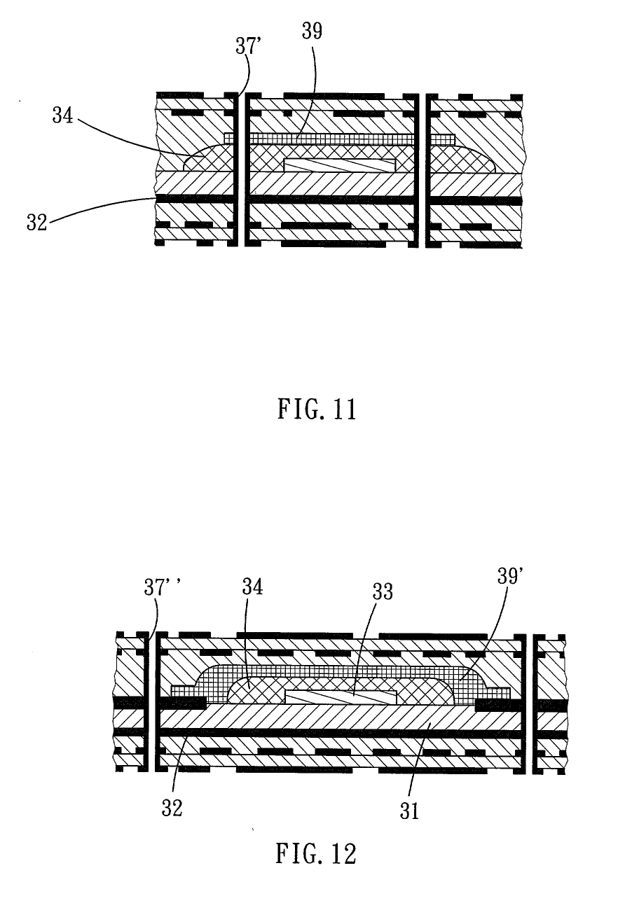

Referring to FIG. 11,a conductive layer 39 is provided on the high dielectric value material 34, and the copper through holes 37′ may be used to connect the lines between the multiple layers, thereby shorting the conductive layer 39 and the metallic ground layer 32.

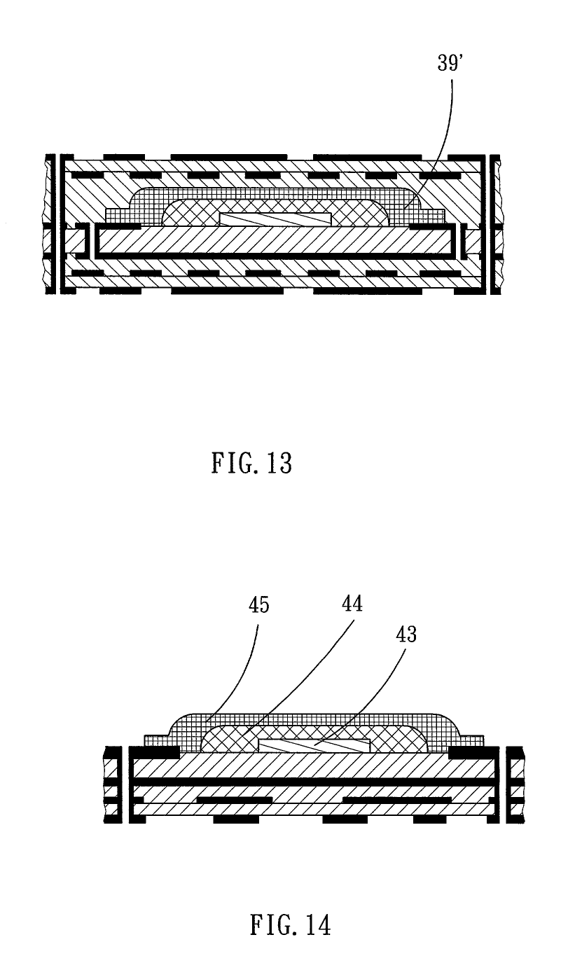

As shown in FIGS. 12 and 13, in the multi-layer printed circuit board, the conductive layer 39′ entirely covers the high dielectric value material 34 and the microstrip transmission lines of the line layer 33, and the conductive layer 39′ further expands to the copper lines connected to the copper through holes 37″, thereby shorting the conductive layer 39′ and the metallic ground layer 32.

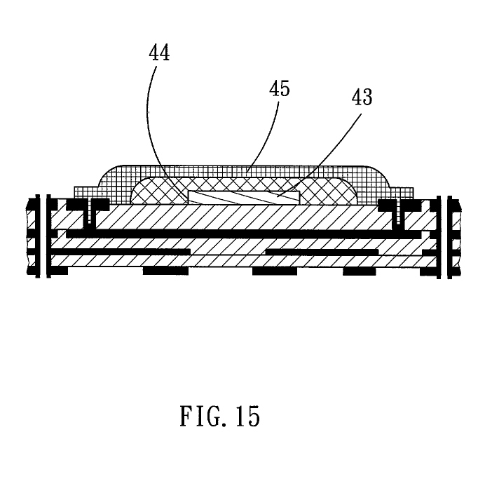

As shown in FIGS. 14 and 15, in the multi-layer printed circuit board, the line layer 43 of the microwave circuit is formed on the outermost layer of the multi-layer printed circuit board. Then, a high dielectric value material 44 is coated on the line layer 43, and a conductive layer 45 is coated on the high dielectric value material 44, so that the conductive layer 45 entirely covers the high dielectric value material 44 and the microstrip transmission lines of the line layer 43, and the conductive layer 45 further expands to the copper lines connected to the copper through holes, thereby shorting the conductive layer 45 and the metallic ground layer.

When the conductive layer is coated on the high dielectric value material, three manners may be used to short the conductive layer and the metallic ground layer as follows:

1. As shown in FIG. 11, the copper through holes directly pass through the conductive layer and the metallic ground layer.

2. As shown in FIGS. 13-15, when the microstrip transmission lines of the line layer of the microwave circuit are made, the copper lines are made at the same layer. The copper lines may connect the metallic ground layer by the copper through holes. When the conductive layer is coated, the conductive layer may be further expanded to the copper lines, so that the conductive layer electrically connects the metallic ground layer.

3. As shown in FIG. 12, when the microstrip transmission lines of the line layer of the microwave circuit are made, the copper lines are made at the same layer. When the conductive layer is coated, the conductive layer may be further expanded to the copper lines and overlapped with other circuit substrates, and then connected with the copper lines and the metallic ground layer, so that the conductive layer electrically connects the metallic ground layer.

Accordingly, the method of the present invention may efficiently reduce the size of the microwave circuit by increasing the effective dielectric constant of the dielectric material, without affecting the electrical function of the microwave circuit.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A method of shortening a size of a microwave circuit, comprising the steps of:
a) determining a pre-estimated value of an effective dielectric constant;
b) determining a shortened size of a microwave circuit according to the pre-estimated value of the effective dielectric constant and a used working frequency;
c) making the microwave circuit according to the shortened size that is determined; and
d) means for increasing an effective dielectric constant of the dielectric material of the microwave circuit to be equal to the pre-estimated value of the effective dielectric constant.

2. The method of shortening a size of a microwave circuit in accordance with claim 1, wherein in the step d), the means for increasing an effective dielectric constant of the dielectric material includes the step of:
providing a high dielectric value material to cover transmission lines of a line layer of the microwave circuit.

3. The method of shortening a size of a microwave circuit in accordance with claim 2, wherein the high dielectric value material is provided by printing.

4. The method of shortening a size of a microwave circuit in accordance with claim 2, wherein the high dielectric value material is provided by coating.

5. The method of shortening a size of a microwave circuit in accordance with claim 2, further comprising the steps of:
providing a conductive layer on the high dielectric value material to cover the transmission lines of the line layer of the microwave circuit.

6. The method of shortening a size of a microwave circuit in accordance with claim 5, wherein the conductive layer is provided by printing.

7. The method of shortening a size of a microwave circuit in accordance with claim 5, wherein the conductive layer is provided by coating.

8. The method of shortening a size of a microwave circuit in accordance with claim 1, wherein the means for increasing an effective dielectric constant of the dielectric material includes the step of:
using a high dielectric value material to make a dielectric substrate having a high dielectric value; and
using the dielectric substrate to make the microwave circuit.

9. A printed circuit board, comprising:
a dielectric substrate;
a metallic ground layer mounted on a first side of the dielectric substrate;
a line layer mounted on a second side of the dielectric substrate; and
a high dielectric value material mounted on the line layer.

10. The printed circuit board in accordance with claim 9, wherein the printed circuit board may overlap other circuit substrates, and connect lines between multiple layers by copper holes, thereby forming a multi-layer printed circuit board.

11. The printed circuit board in accordance with claim 9, further comprising a conductive layer mounted on the high dielectric value material to cover transmission lines of the line layer.

12. The printed circuit board in accordance with claim 11, wherein the printed circuit board may overlap other circuit substrates, and connect lines between multiple layers by copper holes, thereby forming a multi-layer printed circuit board.

13. The printed circuit board in accordance with claim 11, wherein the conductive layer is connected with the metallic ground layer by copper holes.

14. The printed circuit board in accordance with claim 9, wherein the high dielectric value material is formed by adding ceramic powder in a resin.

15. The printed circuit board in accordance with claim 9, wherein the high dielectric value material has a dielectric constant greater than 5.

16. The printed circuit board in accordance with claim 9, wherein the conductive layer is formed of high molecular material of high conductance.

17. A printed circuit board, comprising:
a dielectric substrate made of a high dielectric value material;
a metallic ground layer mounted on a first side of the dielectric substrate; and
a line layer mounted on a second side of the dielectric substrate.

18. The printed circuit board in accordance with claim 17, wherein the printed circuit board may overlap other circuit substrates, and connect lines between multiple layers by copper holes, thereby forming a multi-layer printed circuit board.

19. The printed circuit board in accordance with claim 17, wherein the high dielectric value material is formed by adding ceramic powder in a resin.

20. The printed circuit board in accordance with claim 17, wherein the high dielectric value material has a dielectric constant greater than 5.
